(19) United States
(12) Patent Application Publication
(10) Pub. No.: US 2004/0148222 A1
(43) Pub. Date: Jul. 29, 2004

(54) Method and system for online advertising

(76) Inventors: John Sabella, Bayport, NY (US); James Waltz, New York, NY (US)

Correspondence Address: KENYON & KENYON, ONE BROADWAY, NEW YORK, NY, 10004, US

(21) Appl. No.: 10/351,689

(22) Filed: Jan. 24, 2003

(51) Int. Cl. G06F 17/60

(52) U.S. Cl. 705/14

(57) ABSTRACT

A method and a system for online advertising in an advertisement auction environment. A current cost per click (CPC) for the advertisement is calculated. A click through rate (CTR) for the advertisement is calculated. An effective cost for the advertisement is calculated. Also, effective costs of a set of advertisements are calculated. The effective cost of the advertisement is compared with the effective costs of the set of advertisements to determine rankings of the advertisement and the set of advertisements. Priority statuses of the advertisement and of the set of advertisements are determined. A first set of data is transmitted to an advertiser that includes the effective cost for the advertisement, the effective costs of the set of advertisements, the rankings of the advertisement and the set of advertisements, the maximum price to the first priority status, the click through rate of the advertisement, the first rank status click through rate (the CTR for the best performing advertisement), a maximum price for a collection of advertisements that the advertisement is associated with, the priority statuses of the advertisements, and other data. A second set of data is received from the advertiser that includes changes to the advertisement and to the current CPC of the advertisement.

### FIELD OF THE INVENTION

The present invention relates to a system and method for online advertising.

### BACKGROUND INFORMATION

Online advertising over the Internet is highly popular among advertisers. Online advertisements may be targeted to search words that consumers type into Internet search engines. In turn, associations with search words may be sold to advertisers. These associations determine how and when advertisements are displayed to consumers over the Internet.

### SUMMARY OF THE INVENTION

The method and system according to the present invention provides for online advertising in an advertisement auction environment. A current cost per click (CPC) for the advertisement is calculated: The CPC defines the price that the advertiser is willing to pay to the advertising provider each time a consumer clicks on the advertisement. A click through rate (CTR) for the advertisement is calculated. The CTR for the advertisement is a ratio that represents the number of times that the advertisement has been accessed by consumers over the Internet divided by the number of times the advertisement has been displayed to consumers over the Internet. An effective cost for the advertisement is calculated. The effective cost is calculated by use of the CTR of the advertisement and the CPC of the advertisement. Effective costs of a set of advertisements are calculated. The set of advertisements are related to the advertisement by manner of being associated with the same keyword. The effective cost of the advertisement is compared with the effective costs of the set of advertisements to determine rankings of the advertisement and the set of advertisements. Ranking are determined as a function of the effective cost of the advertisement and the effective costs of the set of advertisements. Priority statuses of the advertisement and of the set of advertisements are determine. A first set of data is transmitted to an advertiser. The first set of data includes the effective cost for the advertisement, the effective costs of the set of advertisements, the rankings of the advertisement and the set of advertisements, the maximum price to the first priority status, the click through rate of the advertisement, the first rank status click through rate (the CTR for the best performing advertisement), a maximum price for a collection of advertisements that the advertisement is associated with, the priority statuses of the advertisements, and other data. A second set of data is received from the advertiser. The second set of data may include changes to the advertisement and to the current CPC of the advertisement. After the advertiser views the first set of data, the advertiser makes changes regarding the advertisement, the keyword corresponding to the advertisement, and prices relating to the advertisement, the keyword, and current CPC of the advertisement. In turn, the advertiser changes the keyword, alters the advertisement, resets the prices set for the advertisement, books advertisements and keywords, alters the current CPC of the advertisement, and alters other features relating to the advertisement by manner of the second set of data that the advertising provider receives from the advertiser.

### BRIEF DESCRIPTION OF THE DRAWINGS

FIG. 1 shows an exemplary method according to the present invention.

FIG. 2 shows an exemplary system according to the present invention.

### DETAILED DESCRIPTION

An online advertisement may be a graphical advertisement unit (e.g., a banner advertisement), a text advertisement unit, an animated advertisement unit, a video advertisement unit, or any other type of advertisement unit that is presentable over the Internet. The online advertisement is associated with a keyword that relates to search words that consumers may type into Internet search engines. For example, an advertisement for a manufacturer of sporting equipment may be associated with the keyword “sports”. When consumers type in “sports” as a search word in an Internet search engine, various advertisements may be displayed to the consumers that are associated with the “sports” keyword. Hence, an advertising provider may sell advertisement priority to advertisers based on prices and costs that advertisers are willing to pay to have their advertisement associated with a keyword. Various advertisements, from different advertisers, may be associated with a single keyword.

The method and system according to the present invention provide for online advertising in an advertisement auction environment. The advertisement auction environment presents advertisers with information regarding their advertisements in relation to advertisements of competing advertisers. Advertisements in the auction environment are related such that the advertisements are associated with the same keyword. An advertiser may make bids relating to a cost and price for its advertisement in order to get priority over other advertisements.

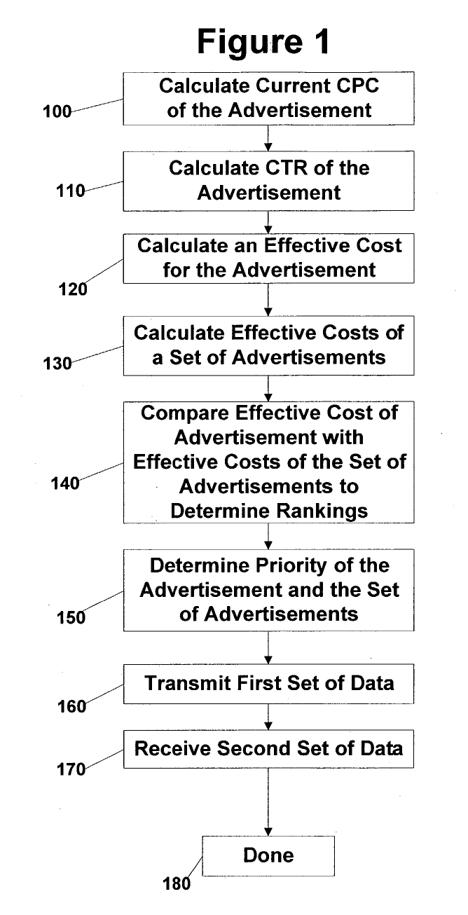

FIG. 1 shows an exemplary method according to the present invention. The method according to the present invention provides for online advertising in an advertisement auction environment. In step 100, a current cost per click (CPC) for the advertisement is calculated. The current CPC may be a predefined value that is set by the advertiser. The CPC defines the price that the advertiser is willing to pay to the advertising provider each time a consumer clicks on the advertisement and then accesses the advertisement and other related advertisement data via the Internet. For example, advertiser A has an advertisement associated with the keyword “sports” and advertiser A has set the CPC for this advertisement at $3.00.

A database may be maintained by the advertising provider that tracks and records the CPC of the advertisement as set by the advertiser.

In step 110, a click through rate (CTR) for the advertisement is calculated. The CTR for the advertisement is a ratio that represents the number of times that the advertisement has been accessed by consumers over the Internet divided by the number times the advertisement has been displayed to consumers over the Internet.

A database may be maintained by the advertising provider that tracks and records both the number of times the advertisement has been accessed by consumers and the number of advertisements displayed to consumers over the Internet.

In step 120, an effective cost for the advertisement is calculated. The effective cost may be calculated by referencing a database and obtaining the CTR and CPC of the advertisement. The effective cost (EC) may be calculated using the following formula:

EC=CTR*CPC*X

where X represents a degree to which the effective cost is calculated.

The effective cost may be calculated to varying monetary degrees. For example, the effective cost may be calculated as the effective cost per mill (1/10 of a cent, i.e., x=1000). To calculate an effective cost per mill (ECPM), the following formula is used:

ECPM=CTR*CPC*1000.

In step 130, effective costs of a set of advertisements are calculated. The set of advertisements are related to the advertisement by manner of being associated with the same keyword. For example, advertiser A, advertiser B and advertiser C each have an advertisement associated with the keyword “sports”. Hence, the set of advertisements includes the advertisements of advertiser B and advertiser C. The effective costs for each of the advertisements of advertiser B and advertiser C are calculated in the same manner described above in reference to step 120.

In step 140, the effective cost of the advertisement is compared with the effective costs of the set of advertisements to determine rankings of the advertisement and the set of advertisements. Ranking are determined as a function of the effective cost of the advertisement and the effective costs of the set of advertisements. For example, advertiser A's advertisement has an effective cost of $3.25, advertiser B's advertisement has an effective cost of $4.25, and advertiser C's advertisement has an effective cost of $2.25. Hence, the advertisement of advertiser B has the highest effective cost and this advertisement is ranked first. The advertisement of advertiser A is ranked second and the advertisement of advertiser C is ranked third.

In step 150, priority statuses of the advertisement and of the set of advertisements are determined. For example, advertiser A's advertisement is ranked second and so it has a second priority status. Advertiser B's advertisement is ranked first and so it has a first priority status. Advertiser C's advertisement is ranked third and so it has a third priority status. Hence, the advertisement of advertiser B is displayed most often to consumers because it has the first priority status.

In an exemplary embodiment according to the present invention, the priority statuses may be rotational priority statuses. On the Internet, advertisements may be displayed in a specific advertisement area in a web page. The advertisement area may have different advertisements displayed there on a rotational basis. In reference to the above example, advertiser A's advertisement is ranked second and so it has a second rotational priority status. Advertiser B's advertisement is ranked first and so it has a first rotational priority status. Advertiser C's advertisement is ranked third and so it has a third rotational priority status. Hence, the advertisement of advertiser B is displayed most often on the advertisement area because it has the first rotational priority status. As advertisements are displayed on a rotational basis on the advertisement area, priority is given to the advertisement with the highest rotational priority status.

In step 160, a first set of data is transmitted to an advertiser. The first set of data may include the effective cost for the advertisement, the effective costs of the set of advertisements, the rankings of the advertisement and the set of advertisements, the maximum price to the first priority status, the click through rate of the advertisement, the first rank status click through rate (the CTR for the best performing advertisement), a maximum price for a collection of advertisements that the advertisement is associated with, the priority statuses of the advertisements, and other data.

In step 170, a second set of data is received from the advertiser. The second set of data may include changes to the advertisement and to the current CPC of the advertisement. After the advertiser views the first set of data transmitted in step 160, the advertiser may make decisions regarding the advertisement, the keyword corresponding to the advertisement, prices relating to the advertisement, and the current CPC of the advertisement. In turn, the advertiser may change the keyword associated with the advertisement, alter the advertisement, reset the prices set for the advertisement, book advertisements and keywords, alter the current CPC of the advertisement, and alter other features relating to the advertisement by manner of the second set of data that the advertising provider receives from the advertiser in step 170.

In step 180, the method according to the present invention is complete and ends. 1.0

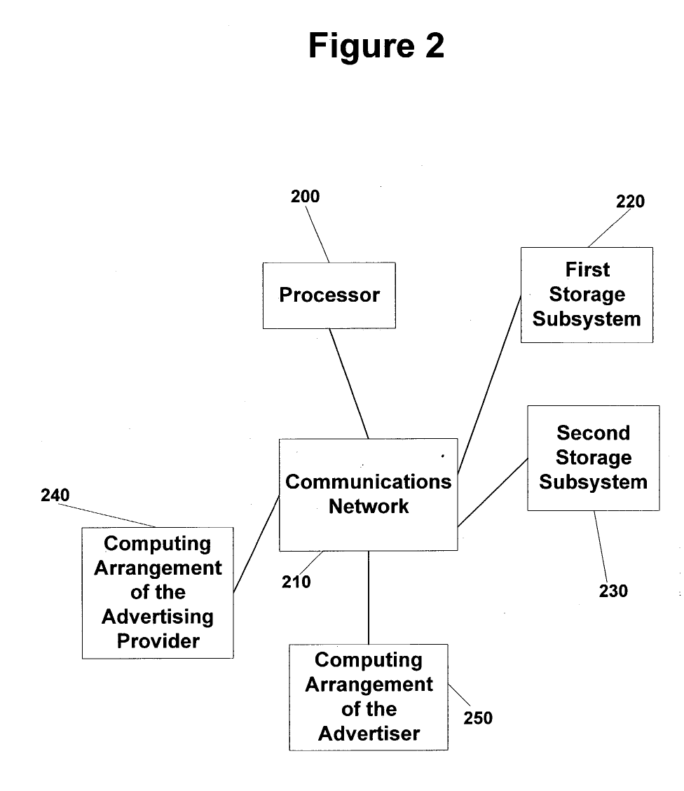

FIG. 2 shows an exemplary system according to the present invention. The system is configured to execute the method described above in reference to FIG. 1. A processor 200 executes the method according to the present invention. The processor 200 may include a computer server arrangement. The method according to the present invention is stored as a set of instructions that is accessible and executable by the processor 200. This set of instructions is stored in a first storage subsystem 220 that may be a compact disk, hard drive, DVD-ROM, CD-ROM or any type of computer-readable storing medium. The first storage subsystem 220 may be included within a computing arrangement 240 of the advertising provider. The computing arrangement 240 of the advertising provider may be a personal computer, a computer network, a wireless computing device or a wireless computing network. The computing arrangement 240 of the advertising provider communicates with the processor 200 via a communications network 210. The processor 200 uses the set of instructions stored on the first storage subsystem 220 to provide online advertising by manner of the exemplary method according to the present invention. A second storage subsystem 230 includes a database that stores advertisements, keywords, CPCs of advertisements, CTRs of advertisements, effective costs of advertisements, rankings of advertisements, priority statuses of advertisements and other data. The second storage subsystem 220 may be included within the computing arrangement 240 of the advertising provider.

The processor 200 communicates with the database stored on the second storage subsystem 230 and the first storage subsystem 220 via the communications network 210. The processor 200 uses the communications network 210 to transmit the first set of data, described above in reference to FIG. 1, to the computing arrangement 250 of the advertiser. The computing arrangement 250 of the advertiser may be a personal computer, a computer network, a wireless computing device or a wireless computing network. The advertiser views the first set of data and then the advertiser may change the keyword associated with the advertisement, alter the advertisement, reset the prices set for the keyword, book advertisements, the CPC of the advertisement and alter other features relating to the advertisement by sending a second set of data to the advertising provider via the computing arrangement 250 of the advertiser. The second set of data sent by the advertiser is received by the advertising provider via the communications network 210. The processor 200 handles the second set of data sent by the advertiser and records the data in the database stored on the second subsystem 230. Appropriate changes are recorded in the database to reflect changes that the advertiser desires to make to the advertisement, the prices set for the advertisement, the CPC of the advertisement, and other features relating to the advertisement.

What is claimed is:

1. A method for online advertising in an advertisement auction environment, comprising:
(a) calculating a current cost per click for an advertisement, the cost per click being a price for the advertisement;
(b) calculating a click through rate of the advertisement, the click through rate being a ratio of a number of times the advertisement has been accessed divided by a number of times that the advertisement has been displayed;
(c) calculating an effective cost of the advertisement as a function of the cost per click and the click through rate;
(d) calculating effective costs for a set of advertisements, each of the set of advertisements being related to the advertisement;
(e) comparing the effective cost of the advertisement and the effective costs of the set of advertisements to determine rankings, the rankings ranking the advertisement and the set of advertisements;
(f) determining priority statuses of the advertisement and the set of advertisements;
(g) transmitting a first set of data including the current cost per click for the advertisement, the click through rate of the advertisement, the effective cost of the advertisement, the effective costs for the set of advertisements, the rankings, and the priority statuses; and
(h) receiving a second set of data relating to the advertisement, the second set of data including changes to the advertisement and to the current cost per click;
wherein the advertising auction environment presents a plurality of advertisers with data regarding advertisements.

2. The method of claim 1, wherein the method is performed using a computing arrangement in communication with a processor via a communications network.

3. The method of claim 2, wherein the processor includes a computer server arrangement.

4. A computer-readable storing medium storing a set of instructions, the set of instructions capable of being executed by a processor to implement a method for online advertising in an advertisement auction environment, the set of instructions performing the steps of:
(a) calculating a current cost per click for an advertisement, the cost per click being a price for the advertisement;
(b) calculating a click through rate of the advertisement, the click through rate being a ratio of a number of times the advertisement has been accessed divided by a number of times that the advertisement has been displayed;
(c) calculating an effective cost of the advertisement as a function of the cost per click and the click through rate;
(d) calculating effective costs for a set of advertisements, each of the set of advertisements being related to the advertisement;
(e) comparing the effective cost of the advertisement and the effective costs of the set of advertisements to determine rankings, the rankings ranking the advertisement and the set of advertisements;
(f) determining priority statuses of the advertisement and the set of advertisements;
(g) transmitting a first set of data including the current cost per click for the advertisement, the click through rate of the advertisement, the effective cost of the advertisement, the effective costs for the set of advertisements, the rankings, and the priority statuses; and
(h) receiving a second set of data relating to the advertisement, the second set of data including changes to the advertisement and to the current cost per click;
wherein the advertising auction environment presents a plurality of advertisers with data regarding advertisements.

5. The computer-readable storing medium of claim 4, wherein the method is performed using a computing arrangement in communication with a processor via a communications network.

6. The computer-readable storing medium of claim 5, wherein the processor includes a computer server arrangement.

7. A system comprising:
a processor;
at least one computing arrangement configured to communicate with the processor via a communications network; and
a computer-readable storing medium storing a set of instructions, the set of instructions capable of being executed by the processor to implement a method for online advertising in an advertisement auction environment, the set of instructions performing the steps of:
(a) calculating a current cost per click for an advertisement, the cost per click being a price for the advertisement;
(b) calculating a click through rate of the advertisement, the click through rate being a ratio of a number of times the advertisement has been accessed divided by a number of times that the advertisement has been displayed;
(c) calculating an effective cost of the advertisement as a function of the cost per click and the click through rate;
(d) calculating effective costs for a set of advertisements, each of the set of advertisements being related to the advertisement;
(e) comparing the effective cost of the advertisement and the effective costs of the set of advertisements to determine rankings, the rankings ranking the advertisement and the set of advertisements;
(f) determining priority statuses of the advertisement and the set of advertisements;
(g) transmitting a first set of data including the current cost per click for the advertisement, the click through rate of the advertisement, the effective cost of the advertisement, the effective costs for the set of advertisements, the rankings, and the priority statuses; and
(h) receiving a second set of data relating to the advertisement, the second set of data including changes to the advertisement and to the current cost per click;
wherein the advertising auction environment presents a plurality of advertisers with data regarding advertisements.
